(19) United States
(12) Patent Application Publication
(10) Pub. No.: US 2005/0085145 A1
(43) Pub. Date: Apr. 21, 2005

(54) Flame resistant

(76) Inventors: Xinggao Fang, Duncan, SC (US); Kim Sasser, Cowpens, SC (US)

Correspondence Address: John E. Vick, Jr.;Legal Department, M-495, PO Box 1926, Spartanburg, SC, 29304, US

(21) Appl. No.: 10/689,875

(22) Filed: Oct. 21, 2003

(51) Int. Cl. B32B 27/04; B32B 3/00; B32B 9/00; B32B 5/02; B32B 27/12

(52) U.S. Cl. 442/95; 428/920; 428/921; 442/93; 442/94; 442/118; 442/136; 442/169; 442/168; 442/172

(57) ABSTRACT

Certain compositions provide excellent repellency, durability, and soil/stain release properties when applied to a textile or fabric. A textile substrate for fire resistant garments and the like which provides good repellency and stain/soil release is disclosed. Such compositions may include: a repellent component and a crosslinking component. A method for applying such compositions to textiles also is disclosed.

### BACKGROUND OF THE INVENTION

Various compositions have been applied to textiles in an effort to achieve good repellency of such textiles when contacted with liquids, such as oils and water. Thus, it is desirable to provide textiles or fabric with repellency characteristics.

Such textiles having repellency are particularly useful in fabrics that are employed as protective garments for fire fighters, chemical plant personnel, and other occupations in which exposure to chemicals or temperature extremes are likely to be encountered.

U.S. Pat. No. 6,606,749 B2 to Underwood et al. is directed to a protective garment for fire fighters with water resistance properties. A durable water resistant coating is applied to the outer shell of the garment. The coating, and the repellency, is said to be durable to laundering of the garment.

Unfortunately, even garments that exhibit good repellency still may be ruined and permanently stained by contact with certain substances, such as oil-based materials. Compositions that impart high degrees of water repellency, due to their highly hydrophobic nature, tend to trap oil-based stains. This can make it difficult or impossible to remove such stains by laundering. Thus, a firefighting garment that encounters oil-based stains may have a permanently ruined or damaged appearance that cannot be reversed by laundering. Such garments, and other flame retardant textiles, desirably should have good stain release properties so that such textiles may achieve a long life, and maintain a suitable appearance.

What is needed in the industry are improved textile substrates and substrates and compositions for coating such substrates that facilitate a relatively high degree of oil and water repellency in a textile application without sacrificing good soil and stain release from such textiles upon laundering. In particular, it would be desirable to provide a formulation for application to textiles that is capable of affording to such textiles release of stains to maintain the appearance of the textile upon cleaning. This invention is directed to improved textiles, compositions and methods for making such textiles.

### DETAILED DESCRIPTION OF THE INVENTION

Reference now will be made to the embodiments of the invention, one or more examples of which are set forth below. Each example is provided by way of explanation of the invention, not as a limitation of the invention. In fact, it will be apparent to those skilled in the art that various modifications and variations can be made the invention without departing from the scope or spirit of the invention.

Surprisingly, it has been discovered that certain specific compositions provide excellent repellency and soil/stain release when applied to a textile or fabric. In one embodiment of the invention the composition comprises at least the following: a fluorochemical component and a crosslinking component which result in a treated textile having superior soil release characteristics.

### Definitions and Terms

“Water repellency” and “oil repellency” are generally defined as the ability of a substrate to block water and oil from penetrating into the substrate, respectively. For example, the substrate may be a textile substrate which is capable of blocking water and oil from penetrating into the fibers of the textile substrate.

“Stain release” generally refers to the degree to which a stained substrate approaches its original, unstained appearance as a result of a care procedure.

The term “stain or soil resistant composition or stain or soil resistant treatment” as used herein refers to any treatment or composition that imparts stain resistance to fibers.

“Durability” is generally defined as the ability of a substrate to retain an acceptable level of a desired function through a reasonable number of standard cleaning cycles. More specifically, durability, as described herein, describes a substrate that maintains adequate properties of stain resistance, water repellency, oil repellency, and soil release. This substrate may be a textile substrate, such as, for example, a polyester textile fabric, or alternatively may be a carpet, or yet another textile material.

The terms “fluorocarbons,” “fluoropolymers,” and “fluorochemicals” may be used interchangeably herein and each represents a polymeric material containing at least one fluorinated segment.

The term “padded” indicates that a liquid coating was applied to a substrate or textile by passing the substrate through a bath and subsequently through squeeze rollers.

“Hydrophilic” is defined as having a strong affinity for or the ability to absorb water.

“Hydrophobic” is defined as lacking affinity for or the ability to absorb water.

### Textile Substrate

In the practice of the invention, several different substrate fibers may be employed in the construction of a woven, knit, or nonwoven textile substrate. For example, PBI (polybenzimidazole) fibers may be employed. PBI brand fibers may be obtained from Celanese Corporation.

Other fibers that can be employed in the base textile construction are para-aramid fibers, or fibers having an aramid derivation, such as KEVLAR™ and NOMEX™, each available from DuPont. Twaron™ fibers from the Teijin Twaron Company also may be employed, which are 100% spun yarn fibers that are para-aramids, employing para-aramid polymers.

Rayon fibers, including flame retardant rayon fibers, also may be employed, including fibers such as those produced by Lenzing Fibers Corporation. Rayon is a manufactured fiber composed of regenerated cellulose, including substitutions for no more than about 15% of the hydrogens of the hydroxy groups.

In one embodiment of the invention, a textile substrate, or fabric, employing PBI fibers, para-aramid fibers, and rayon fibers having flame retardant (“rayon-FR”) may be employed in the textile. In that instance, for example, the fabric may be constructed of a 2×1 twill, with a 38/2 warp and filling yarn, and about 66 ends per inch, with about 56 picks per inch.

The textile may be comprised as well of fibers having at least one fire resistant material selected from the group consisting of: meta-aramids, para-aramids, fluoropolymers and copolymers, chloropolymers and copolymers, polybenzimidazole, polyimides, polyamideimides, partially oxidized polyacrylonitriles, novoloids, poly (p-phenylene benzobisoxazoles), poly (p-phenylene benzothiazoles), polyphenylene sulfides, flame retardant viscose rayons, polyvinyl chloride homopolymers and copolymers, polyetherketones, polyketones, polyetherimides, and polylactides.

Fire resistant fibers may be employed including melamine, for example, that sell under the tradename BASOFIL by BASF; meta-aramids such as poly(m-phenylene isophthalamide), for example, those sold under the tradenames NOMEX by E. I. Du Pont de Nemours and Co., TEIJINCONEX by Teijin Limited and FENYLENE by Russian State Complex; para-aramids such as poly(p-phenylene terephthalamide), for example, that sold under the tradename KEVLAR by E. I. Du Pont de Nemours and Co., poly(diphenylether para-aramid), for example, that sold under the tradename TECHNORA by Teijin Limited, and those sold under the tradenames TWARON by Acordis and FENYLENE ST (Russian State Complex); fluoropolymers such as polytetrafluoroethylene (PTFE), for example, those sold under the tradenames TEFLON TFE by E. I. Du Pont de Nemours and Co., LENZING PTFE by Lenzing A. G., RASTEX by W.R. Gore and Associates, GORE-TEX by W.R. Gore and Associates, PROFILEN by Lenzing A. G. and TOYOFLON PTFE by Toray Industries Inc., poly(ethylene-chlorotrifluoroethylene) (E-CTFE), for example, those sold under the tradenames HALAR by Albany International Corp. and TOYOFLON E-TFE by Toray Industries Inc., polyvinylidene fluoride (PVDF), for example, those sold under the tradenames KYNAR by Albany International Corp. and FLORLON (Russian State Complex), polyperfluoroalkoxy (PFA), for example, those sold under the tradenames TEFLON PFA by E. I. Du Pont de Nemours and Co. and TOYOFLON PFA by Toray Industries Inc., polyfluorinated ethylene-propylene (FEP), for example, that sold under the tradename TEFLON FEP by E. I. Du Pont de Nemours and Co.; polybenzimidazole such as that sold under the tradename PBI by Hoechst Celanese Acetate LLC, polyimides, for example, those sold under the tradenames P-84 by Inspec Fibers and KAPTON by E. I. Du Pont de Nemours and Co.; polyamideimides, for example, that sold under the tradename KERMEL by Rhone-Poulenc; partially oxidized polyacrylonitriles, for example, those sold under the tradenames PORTAFIL OPF by Fortafil Fibers Inc., AVOX by Textron Inc., PYRON by Zoltek Corp., PANOX by SGL Technik, THORNEL by American Fibers and Fabrics and PYROMEX by Toho Rayon Corp.; novoloids, for example, phenol-formaldehyde novolac, for example, that sold under the tradename KYNOL by Gun Ei Chemical Industry Co.; poly (p-phenylene benzobisoxazole) (PBO), for example, that sold under the tradename ZYLON by Toyobo Co.; poly (p-phenylene benzothiazoles) (PBT); polyphenylene sulfide (PPS), for example, those sold under the tradenames RYTON by American Fibers and Fabrics, TORAY PPS by Toray Industries Inc., FORTRON by Kureha Chemical Industry Co. and PROCON by Toyobo Co.; flame retardant viscose rayons, for example, those sold under the tradenames LENZING FR by Lenzing A. G. and VISIL by Kemira Fibres Oy; polyvinyl chloride homopolymers and copolymers, for example, those sold under the tradenames VINYON HH, RHOVYL by Rhovyl S. A., CLEVYL, THERMOVYL by Rhovyl S. A., FIBRAVYL by Rhovyl S. A., RETRACTYL by Rhovyl S. A., PIVIACID, ISOVYL by Rhovyl S. A., VICLON by Kureha Chemical Industry Co., TEVIRON by Teijin Ltd., CORDELAN, ENVILON Toyo Chemical Co. and VICRON, made in Korea; modacrylics, for example, those sold under the tradenames PROTEX by Kaneka and SEF by Solutia; chloropolymers and copolymers such as polyvinylidene chloride copolymers, for example, those sold under the tradenames SARAN by Pittsfield Weaving, KREHALON by Kureha Chemical Industry Co. and OMNI-SARAN by Fibrasomni, S. A. de C.V.; polyetheretherketones (PEEK), for example, that sold under the tradename ZYEX by Zyex Ltd.; polyketones (PEK), for example, that sold under the tradename ULTRAPEK by BASF; polyetherimides (PEI), for example, that sold under the tradename ULTEM by General Electric Co.; polylactides such as those available from Cargill Dow Polymers; and combinations thereof.

Of course, several fiber types may be blended with the fire resistant fibers. These additional fibers may include non-flame-resistant fibers, for example, cottons, wools, nylons, polyesters, polyolefins, rayons, acrylics, silks, mohair, cellulose acetate, polyvinyl alcohols (PVA), for example, those sold under the tradenames CREMONA by Kuraray, KURALON by Kuraray, KURALON KII by Kuraray, MEWLON by Unitika Chemical Co., NITI-VELON by Nitivy Company Ltd., SOLVRON by Nitivy Company Ltd. and VILON by Nitivy Company Ltd., polyethylene napththalates, for example, that sell under the tradename PENTEX by Honeywell, and combinations thereof.

### Fluorinated Soil Release Component

Specific commercially available examples of fluorinated soil release components include, without limitation, Repearl SR-1100® (available from Mitsubishi International Corporation) flubro-acrylate copolymer, and Baygard SOC™ (Bayer Corporation)(identify the chemical nature of this one fluoroalkyl acrylate copolymer; and Zonyl 7910™, 9200™ (from Ciba Corporation) (fluoro-urethane copolymer).

Fluoroacrylate polymers and urethane fluoropolymers may serve as good soil release compositions. Unidyne TG-992™ from Daikin Corporation is a fluoroacrylate which imparts good repellency and excellent soil/stain release properties when applied to a textile. Unidyne TG-993™ (Daikin Corporation), FC 248™ and PM 490™ (3M Company) may be employed as well. There are numerous fluorocarbon or fluorochemical compositions having stain or soil release capability that can be employed.

### Crosslinking Component

Cross-linking components also may be included in the invention, including those cross-linking components which are essentially insoluble in water, also known as hydrophobic. Hydrophilic crosslinkers (sometimes called “extenders”) may be quite useful.

In one embodiment of the invention, the use of crosslinking components comprised of one or more of the following may prove to be quite useful: melamine formaldehydes and derivatives, epoxides, and anhydrides and derivatives thereof. One such composition is EPI-REZ®) 5003 W55, available from Shell. Another example, is permafresh MFX™, available from Omnova Solutions, Inc.

In other embodiments, hydrophobic cross-linking components may include derivatives of isocyanates (such as blocked diisocyanates), polymers containing blocked isocyanates, epoxy containing compounds, and the like, or combinations thereof. Protected diisocyanate containing chemicals may be the suitable cross-linking components. However, chemicals containing two or more blocked isocyanate compounds may be the most preferred cross-linking components. One useful cross-linking component is REPEARL® MF, also available from Mitsubishi Corp. HYDROPHOBOL® XAN is another compound available from DuPont, which may be employed.

For purposes of the Examples below, Arkophob DAN® is a hydrophobic crosslinking component, which is a protected isocyanate sold by the Clariant Corporation.

The total amount of the chemical composition applied to a substrate, as well as the proportions of each of the chemical components comprising the chemical composition, may vary over a wide range. The total amount of chemical composition applied to a substrate will depend generally on the composition of the substrate, the level of durability required for a given end-use application, and the cost of the chemical composition.

### Application Procedures

Chemical application may be accomplished by immersion coating, padding, spraying, foam coating, or by any other technique whereby one can apply a controlled amount of a liquid suspension to a textile substrate. Employing one or more of these application techniques may allow the composition to be applied to the textile substrate in a uniform manner on one or both faces of the fabric. Many chemical treatments can be incorporated simultaneously with the chemical composition of the current invention, or such treatments may be carried out prior to treatment with the chemical composition of the current invention.

### Other Components and Compositions

Accordingly, it may be desirable optionally to treat the textile substrate with finishes containing additives or other chemicals such as antimicrobial agents, flame retardant agents, durable press resins, catalysts, lubricants, softeners, light stabilizers, antioxidants, coloring agents, antistatic agents, fragrances, and the like, or combinations thereof.

In one specific application of the invention, it may be advantageous to apply a fluorocarbon-containing repellent component, an acrylate or methacrylate-based fluorochemical resin (soil release component), or a urethane fluorochemical, and a crosslinking component. The crosslinking component may be a derivative of isocyanate, in one embodiment.

Atebin 1062™ is a polyethylene sewing lubricant sold by Boehme Filatex Corporation. It has no substantive repellency or stain release action, but instead is applied to improve the sewing characteristics of the textile for manufacture.

### Methods and Procedures

Liquid or stain resistant properties of treated textiles may be measured using water and oil repellency tests.

Water Repellency was tested according to the 3M Water Repellency Test II (May, 1992). The rating scale is 1-10, with “1” indicating the poorest degree of repellency (substrates having higher surface energy) and “10” indicating the best degree of repellency (substrates having lower surface energy). The 3M water repellency scale is:
1 is 10% IPA, 90% water
2 is 20% IPA, 80% water
3 is 30% IPA, 70% water
4 is 40% IPA, 60% water
5 is 50% IPA, 50% water
6 is 60% IPA, 40% water
7 is 70% IPA, 30% water
8 is 80% IPA, 20% water
9 is 90% IPA, 10% water
10 is 100% IPA

Oil Repellency was tested according to the MTCC Test Method 118-1997. The rating scale is 1-8, with “1” indicating the poorest degree of repellency (substrates having higher surface energy) and “8” indicating the best degree of repellency (substrates having lower surface energy). The oil repellency scale is:
1 is NUjOI™ Mineral Oil
2 is 65/35 Nujol/n-hexadecane (by volume)
3 is n-hexadecane
4 is n-tetradecane
5 is n-dodecane
6 is n-decane
7 is n-octane
8 is n-heptane

Soil or stain release property was measured using AATCC test method 130-1981. The wash temperature employed 140 Fahrenheit. The drying temperature was adjusted to “high”. About 90 grams of Tide® brand detergent was used in the washing procedure.

### AATCC Test Method 130-1981

### Soil Release: Oily Stain Release Method

Developed in 1969 by AATCC Committee RA56; reaffirmed 1970,1974, 1977. Editorially revised 1978,1983, 1986; revised 1981.

1.Purpose and Scope

1.1 This test method is designed to measure the ability of a fabric to release oily stains during home laundering.

1.2 This test method is intended for the control of uniformity of soil release finishes during manufacture.

2.Principle

2.1 A stain on a test specimen is produced by using a weight to force a given amount of the staining substance into the fabric. The stained fabric is then laundered in a prescribed manner and the residual stain rated on a scale from 5 to 1 by comparison with a standard stain release replica showing a graduated series of stains.

3. Apparatus and Materials

3.1 AATCC White Textile Blotting Paper (see 10.1).

3.2 Mineral oil, refined (Nujol Brand) (see 10.2).

3.3 Glassine paper or equivalent (see 10.3).

3.4 Timer.

3.5 Weight, cylinder 6.4 cm (2.5 in.) dia., 2.268±0.045 kg (5±0.1 lb) (see 10.4).

3.6 Medicine dropper, straight.

3.7 Washer, automatic (see 10.5).

3.8 Dryer, automatic (see 10.6).

3.9 AATCC Standard Detergent 124 (with optical brightener) (see 10.4).

3.10 Ballast—92×92 cm (36×36 in.) hemmed pieces of cotton sheeting or 50/50 polyester cotton sheeting (see 10.7).

3.11 Lighting and evaluation area (see 10.8).

3.12 Table with “no-glare” black top 61×92 cm (24×36 in.); 92±3 cm (35±1 in.) high.

3.13 Stain Release Replica (see 10.9).

4. Test Specimens

4.1 Use three test specimens, 38×38 cm (15×15 in.), for each determination. Condition the test specimens for a minimum of four hours at 21±1 C (70±2 F) and 65±2% RH prior to application of stains.

5. Staining Procedure

5.1 Place the test specimen flat on a single thickness of AATCC Textile Blotting Paper on a smooth, horizontal surface.

5.2 Using a medicine dropper, place 5 drops (ea. 0.2 ml) Nujol Brand mineral oil (see 10.10) in the approximate center of the test specimen.

5.3 Place a 7.6×7.6 cm (3×3 in.) square of glassine paper over the oil puddle.

5.4 Place the five-pound weight directly over the glassine paper covering the oil puddle.

5.5 Allow the weight to sit undisturbed for 60 seconds.

5.6 Remove weight and discard the glassine sheet.

5.7 Do not allow stained test specimens to contact each other in a manner which would transfer stains. Wash within 15 to 60 minutes after staining.

6. Washing Procedure

6.1 Fill washer to high water levels with water at one of the temperatures from Table 1. Check with thermometer.

6.2 Add 140±5 grams (4.9±0.2 oz) AATCC Standard Detergent 124, or known equivalent, to washer.

6.3 Place test specimens and ballast in washer, making a total load equal 1.8±0.1 kg (4±¼ lb) (see 10.11 ).

6.4 Set the dial on the washer for a “Normal” wash to run for 12 minutes (measured time) and allow cycle to run to completion. (This gives normal agitation in both the wash and rinse).

6.5 At the end of the final spin cycle, place the entire load, test specimens and ballast, into the dryer.

6.6 Dry at the “High” setting, 70±6 C (160±10 F), maximum stack temperature, for 45±5 minutes.

6.7 Remove test specimens from dryer. Rate residual stains within four hours after drying.

TABLE 1
Washing Temperature Selection

| Washing Procedure | Temperature |
|---|---|
| I | 41 ± 3 C. (105 ± 5 F.) |
| II | 49 ± 3 C. (120 ± 5 F.) |
| III | 60 ± 3 C. (140 ± 5 F.) |

7. Evaluation

7.1 Mount the Stain Release Replica on the plywood mounting board, with the center of the standard 107 cm (45 in.) from the floor.

7.2 Place the test specimen flat in the center of the “no-glare” black topped table, with one edge of table touching mounting board.

7.3 Viewing distance shall be 76 cm (30 in.) from the back mounting board, with the eye at 157±15 cm (62±6 in.) from the floor.

7.4 Compare the residual stain on the test specimen with the stains in the Stain Release Replica.

8. Rating Procedure

8.1 Each judging individual should rate each test specimen for residual stain to nearest 0.5 rating according to Table II.

TABLE II
Stain Release Ratings

| | |
|---|---|
| Class 5 | Stain equivalent to Standard Stain 5. |
| Class 4 | Stain equivalent to Standard Stain 4. |
| Class 3 | Stain equivalent to Standard Stain 3. |
| Class 2 | Stain equivalent to Standard Stain 2. |
| Class 1 | Stain equivalent to Standard Stain 1. |

Class 5 represents the best stain removal and Class 1 the poorest stain removal.
9. Report

9.1 Calculate the average of nine ratings for each fabric (three judgements on each of three specimens) to nearest 0.1.

9.2 Indicate washing procedure used by appropriate Roman numeral from Table 1.

9.3 If stains other than the standard mineral oil are used, identify each stain and report the Stain Release Rating obtained for each stain separately.

10. Notes

10.1 AATCC White Textile Blotting paper. Available from AATCC, P.O. Box 12215, Research Triangle Park N.C. 27709.

10.2 Nujol is the trademark of Plough, Inc., for a refined mineral oil. It is available in most drug stores. Saybolt viscosity 360/390 at 38 C (100 F); specific gravity 0.880/0.900 at 15 C (60 F).

10.3 Rhinelander “Blu-White” window envelope glassine −24×36−25#/500. Packages of glassine paper containing a roll 45.7 m long by 30.5 cm wide (150 ft.×1ft.) are available from AATCC, P.O. Box 12215, Research Triangle Park N.C. 27709.

10.4 Cylinder can be manufactured from stainless steel tubing.

10.5 Kenmore Automatic Washer Model 23801 has been accepted as the standard machine. Source: Sears, Roebuck & Co. For address of nearest Commercial Sales Department, write AATCC, P.O. Box 12215, Research Triangle Park N.C. 27709. Approved models of the Kenmore washer can often be found in local Sears, Roebuck & Co. retail stores. Any other washer which is known to give comparable results may be used.

10.6 Kenmore Automatic Dryer Model 65741 (electric) and Model 75741 (gas) have been accepted as the standard machines. The temperature controls are designed so that either the gas or electric models should give equivalent results. Source: Sears, Roebuck & Co. For address of nearest Commercial Sales Department, write AATCC, P.O. Box 12215, Research Triangle Park N.C. 27709. Approved models of the Kenmore dryers can often be found in local Sears, Roebuck & Co. retail stores. Any other dryer known to give comparable results may be used.

10.7 Source: Testfabrics, Inc., P.O. Box 420, Middlesex N.J. 08846.

10.8 Lighting and viewing area as described in AATCC Method 124 (Appearance of Durable Press Fabrics after Repeated Home Launderings); lighting equipment for viewing test specimens with overhead lighting. Place the black topped table with the 92 cm (36 in.) edge against the mounting board.

10.9 The Stain Release Replicas developed by the Deering Milliken Research Corporation are available from AATCC, P.O. Box 12215, Research Triangle Park N.C. 27709.

10.10 Although this test method presently calls for the use of only one standard stain, Nujol brand mineral oil, other non-standard staining substances of interest to the user, in addition to the standard oil, may be applied to the test specimens, using this same technique. In such case, the non-standard stain should be identified in the report.

10.11 The maximum number of test specimens shall be 30, with one stain per specimen, or a proportionately smaller number of test specimens if multiple stains are used on each specimen, e.g., 15 specimens with 2 stains each, etc. In any case, the maximum number of stains shall not exceed 30.

10.12 AATCC Standard Detergent, which is used in this test, is no longer typical of the many types of laundry detergents which are commercially available to the consumer, including for example Tide® detergent, made by Proctor and Gamble Corporation. Users of this method should be aware that currently marketed detergents may give results on fabrics which are different from those obtained with the Standard Detergent. For a more detailed discussion, see the section on AATCC Standard detergent in this manual.

### EXAMPLE 1

A piece of woven PBI/Rayon FR/Twaron textile substrate was immersed in a chemical bath that contains on weight of bath about:
2.5% Unidyne TG-992,
1% of Arkophob DAN, and
1% of Atebin 1062.
   The fabric was passed through a nip of two rolls under about 40 psi pressure. The fabric was finally heated to 350 Fahrenheit for approximately 5 minutes in an oven to remove moisture.

### EXAMPLE 2

Example 1 was repeated, except that about 4% of Unidyne TG-992 and about 2% Arkophob DAN were used instead the two concentrations of Example 1.

### EXAMPLE 3

Example 2 was repeated, except that about 4% Zonyl 7910 was used instead of Unidyne TG-992.

### EXAMPLE 4

Example 2 was repeated, except that a mixture of about 2% Permafresh MFX™ and 0.5% Catalyst 531 was instead of 2% Arkophob DAN.

### COMPARATIVE EXAMPLE EXAMPLE 5

Example 1 was repeated, except that the bath contained only about 1% of Atebin 1062.

### COMPARATIVE EXAMPLE EXAMPLE 6

Example 1 was repeated, except that the bath contained only about 3% Unidyne TG-992 and about 1% of Atebin 1062.

### COMPARATIVE EXAMPLE EXAMPLE 7

Example 2 was practiced, except that 4% Repearl F-7000 was used instead of Unidyne TG-992, and furthermore, 1% Arkophob DAN was used.

### COMPARATIVE EXAMPLE EXAMPLE 8

Example 2 was practiced, except that 4% of Zonyl 7713 (a commercial product believed to be a fluorochemical repellent blended with protected isocyanates components) was used in place of the Unidyne TG-992 and Arkphob DAN.

TABLE 1
Results of Examples

| | Examples | | | | | | | |
|---|---|---|---|---|---|---|---|---|
| | Ex. 1 | Ex. 2 | Ex. 3 | Ex. 4 | Ex. 5 | Ex. 6 | Ex. 7 | Ex. 8 |
| Oil Repellency: 0 Wash | 5 | 5 | 4 | 5 | x | 6 | 3 | 4 |
| Water Repellency: 0 Wash | 4 | 5 | 3 | 6 | x | 1 | 4 | 2 |
| Burned Motor Oil Release: 0/1 | 3.0 | 4.0 | 3 | 4.5 | 1.0 | x | 1 | 1.0 |
| Mineral Oil Release: 0/1 | 4.5 | 4.5 | 4.5 | 4.5 | 1.0 | 4.0 | 2 | 4.5 |
| Corn oil Release: 0/1 | 3.5 | 4.5 | 4.5 | 4.5 | 2.0 | 4.0 | 2 | 4.0 |
| Oil Repellency: 5 Wash | 4 | 5 | 1 | 1 | x | 0 | 2 | 0 |
| Water Repellency: 5 Wash | 3 | 5 | 2 | 1 | x | 0 | 3 | 1 |
| Burned Motor Oil Release: 4/5 | 3.0 | 4.0 | 3.0 | 4.0 | 1 | x | 1 | 1.5 |
| Mineral Oil Release: 4/5 | 4.5 | 4.0 | 4.0 | 4.0 | 2.0 | 4.0 | 1.5 | 3 |
| Corn oil Release: 4/5 | 4.0 | 4.5 | 4.0 | 4.0 | 2.5 | 3.5 | 1.5 | 4 |
| Oil Repellency: 10 Wash | 2 | 4 | x | x | x | x | x | x |
| Water Repellency: 10 Wash | 3 | 4 | x | x | x | x | x | x |
| Burned Motor Oil Release: 9/10 | 3. | 3.0 | x | x | 1 | x | x | x |
| Mineral Oil Release: 9/10 | 4.0 | 4.0 | x | x | 2.5 | 3.5 | x | x |
| Corn oil Release: 9/10 | 4.0 | 4.5 | x | x | 2.5 | 3.5 | x | x |

Note:
Repellency of “0” means textile failed repellency rating of 1.

It is understood by one of ordinary skill in the art that the present discussion is a description of exemplary embodiments only, and is not intended as limiting the broader aspects of the present invention, which broader aspects are embodied in the exemplary constructions. The invention is shown by example in the appended claims.

1. A textile having applied thereon a treating composition, comprising:
(a) a textile substrate comprised of fire resistant fibers;
(b) a treating composition applied to said textile substrate, said treating composition comprising
(i) a fluorochemical component; and
(ii) a crosslinking component;
(c) wherein said textile substrate exhibits according to AATCC test method 130-1981 a stain release value to burned motor oil of at least about 3.0 after at least 5 washes.

2. The textile of claim 1 wherein said fire resistant fibers comprise PBI fibers.

3. The textile of claim 1 wherein said fire resistant fibers comprise para-aramid fibers.

4. The textile of claim 1 wherein said fire resistant fibers comprise rayon-based fibers.

5. The textile of claim 1 wherein said coated textile exhibits an oil repellency according to the AATCC Test Method 118-1997 of at least about 3.

6. A textile having applied thereon a treating composition, comprising:
(a) a textile substrate comprised in part of flame resistant fibers;
(b) a treating composition applied to said textile substrate, said treating composition comprising
(i) a fluorochemical component; and
(ii) a crosslinking component;
(c) wherein said textile substrate exhibits according to AATCC test method 130-1981 a stain release value to corn oil of at least about 3.5 after at least 5 washes.

7. The textile of claim 6 wherein said fire resistant fibers comprise PBI fibers.

8. The textile of claim 6 wherein said textile exhibits an oil repellency according to AATCC Test Method 118-1997 of at least about 3.

9. The textile of claim 7 wherein said textile exhibits a mineral oil stain release value according to AATCC Test Method 130-1981 at least 3.5 after 5 washes.

10. The textile of claim 6 wherein said coated textile exhibits an oil repellency according to the AATCC Test Method 118-1997 of at least about 3.

11. A textile having applied thereon a treating composition, comprising:
(a) a textile substrate comprised in part of flame resistant fibers;
(b) a treating composition applied to said textile substrate, said treating composition comprising
(i) a fluorochemical component; and
(ii) a crosslinking component;
(c) wherein said textile substrate exhibits according to AATCC test method 130-1981 a stain release value to mineral oil of at least about 3.5 after at least 5 washes.

12. The textile of claim 11 wherein said fire resistant fibers comprise PBI fibers.

13. The textile of claim 11 wherein said fire resistant fibers comprise para-aramid fibers.

14. The textile of claim 11 wherein said fire resistant fibers comprise rayon-based fibers.

15. The textile of claim 11 wherein said coated textile exhibits an oil repellency according to the AATCC Test Method 118-2000 of at least about 4.

16. A textile having applied thereon a treating composition, comprising:
(a) a textile substrate comprised in part of rayon-based fibers;
(b) a treating composition applied to said textile substrate, said treating composition comprising
(i) a fluorochemical component; and
(ii) a crosslinking component.

17. The textile of claim 16 wherein said crosslinking component is a derivative of isocyanate.

18. The textile of claim 17 wherein said isocyanate-containing species is a blocked isocyanate.

19. The textile of claim 16 wherein said rayon-based fibers are fire resistant.

20. The textile of claim 16 wherein said textile substrate further comprises PBI fibers.

21. The textile substrate of claim 16 wherein said textile substrate further comprises aramid-containing fibers.

22. A method of making a textile substrate, the method comprising:
(a) providing a coated textile comprised of fire resistant fibers:
(b) providing to said coated textile a treating composition, said treating composition comprising
(i) a fluorochemical component; and
(ii) a crosslinking component;
(c) wherein said coated textile substrate exhibits according to AATCC test method 130-1981 a stain release value to burned motor oil of at least about 3.0 after at least 5 washes.

23. A method of making a textile substrate, the method comprising:
(a) providing a coated textile comprised of fire resistant fibers:
(b) providing to said coated textile a treating composition, said treating composition comprising
(i) a fluorochemical component; and
(ii) a crosslinking component;
(c) wherein said coated textile substrate exhibits according to AATCC test method 130-1981 a stain release value to corn oil of at least about 3.5 after at least 5 washes.

24. A method of making a textile substrate, the method comprising:
(a) providing a coated textile comprised of fire resistant fibers:
(b) providing to said coated textile a treating composition, said treating composition comprising
(i) a fluorochemical component; and
(ii) a crosslinking component;
(c) wherein said coated textile substrate exhibits according to AATCC test method 130-1981 a stain release value to mineral oil of at least about 3.5 after at least 5 washes.
